(19) United States
(12) Patent Application Publication
(10) Pub. No.: US 2026/0259329 A1
(43) Pub. Date: Sep. 3, 2026

(54) PRECISE POSITIONING CORRECTION SERVICE DETERMINATION

(71) Applicant: QUALCOMM Incorporated, San Diego, CA (US)

(72) Inventors: Arun Kumar Sharma TANDRA, Hyderabad (IN); Naveen Kumar ARAVAPALLI, Hyderabad (IN)

(21) Appl. No.: 19/068,136

(22) Filed: Mar. 3, 2025

(51) Int. Cl. G01S 19/07; G01S 19/46; G01S 19/48

(52) U.S. Cl. CPC G01S 19/07; G01S 19/46; G01S 19/48

(57) ABSTRACT

A method of selecting an SPS correction service includes: receiving crowdsourced SPS correction information indicating: (1) a location corresponding to the crowdsourced SPS correction information; (2) a plurality of SPS correction services; (3) a SPS correction for each of the plurality of SPS correction services; and (4) a respective correction service characteristic for one or more of the plurality of SPS correction services; obtaining a position estimate, for a mobile wireless device, comprising one of a present position estimate for the mobile wireless device or a future position estimate for the mobile wireless device; and indicating, based on the position estimate, which of the plurality of SPS correction services are available for the mobile wireless device to use to correct at least one SPS signal received by the mobile wireless device to determine an SPS-signal-corrected position estimate for the mobile wireless device.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc., with a sixth-generation (6G) service in development. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

It is often desirable to know the location and/or motion (e.g., speed or velocity) of a user equipment (UE), e.g., a cellular phone, with the terms “location” and “position” being synonymous and used interchangeably herein. A location services (LCS) client may desire to know the location of the UE and may communicate with a location center in order to request the location of the UE. The location center and the UE may exchange messages, as appropriate, to obtain a location estimate for the UE. The location center may return the location estimate to the LCS client, e.g., for use in one or more applications.

### SUMMARY

An example method of selecting a satellite positioning system (SPS) correction service includes: receiving, at an apparatus, crowdsourced SPS correction information indicating: (1) a location corresponding to the crowdsourced SPS correction information; (2) a plurality of SPS correction services; (3) at least one SPS correction for each of the plurality of SPS correction services; and (4) at least one respective correction service characteristic for each of at least one of the plurality of SPS correction services; obtaining, at the apparatus, a position estimate for a mobile wireless device, the position estimate for the mobile wireless device comprising one of a present position estimate for the mobile wireless device or a future position estimate for the mobile wireless device; and indicating, by the apparatus and based on the position estimate, which of the plurality of SPS correction services are available for the mobile wireless device to use to correct at least one SPS signal received by the mobile wireless device to determine an SPS-signal-corrected position estimate for the mobile wireless device,

An example apparatus includes: at least one memory; at least one transceiver; and at least one processor communicatively coupled to the at least one memory and the at least one transceiver and configured to: receive, via the at least one transceiver, crowdsourced SPS correction information indicating: (1) a location corresponding to the crowdsourced SPS correction information; (2) a plurality of SPS correction services; (3) at least one SPS correction for each of the plurality of SPS correction services; and (4) at least one respective correction service characteristic for each of at least one of the plurality of SPS correction services; obtain a position estimate for a mobile wireless device, the position estimate for the mobile wireless device comprising one of a present position estimate for the mobile wireless device or a future position estimate for the mobile wireless device; and indicate, based on the position estimate, which of the plurality of SPS correction services are available for the mobile wireless device to use to correct at least one SPS signal received by the mobile wireless device to determine an SPS-signal-corrected position estimate for the mobile wireless device.

Another example apparatus includes: means for receiving crowdsourced SPS correction information indicating: (1) a location corresponding to the crowdsourced SPS correction information; (2) a plurality of SPS correction services; (3) at least one SPS correction for each of the plurality of SPS correction services; and (4) at least one respective correction service characteristic for each of at least one of the plurality of SPS correction services; means for obtaining a position estimate for a mobile wireless device, the position estimate for the mobile wireless device comprising one of a present position estimate for the mobile wireless device or a future position estimate for the mobile wireless device; and means for indicating, based on the position estimate, which of the plurality of SPS correction services are available for the mobile wireless device to use to correct at least one SPS signal received by the mobile wireless device to determine an SPS-signal-corrected position estimate for the mobile wireless device.

An example non-transitory, processor-readable storage medium includes processor-readable instructions to cause one or more processors of an apparatus, for selecting a satellite positioning system (SPS) correction service, to: receive crowdsourced SPS correction information indicating: (1) a location corresponding to the crowdsourced SPS correction information; (2) a plurality of SPS correction services; (3) at least one SPS correction for each of the plurality of SPS correction services; and (4) at least one respective correction service characteristic for each of at least one of the plurality of SPS correction services; obtain a position estimate for a mobile wireless device, the position estimate for the mobile wireless device comprising one of a present position estimate for the mobile wireless device or a future position estimate for the mobile wireless device; and indicate, based on the position estimate, which of the plurality of SPS correction services are available for the mobile wireless device to use to correct at least one SPS signal received by the mobile wireless device to determine an SPS-signal-corrected position estimate for the mobile wireless device.

An example method of crowdsourcing satellite positioning system (SPS) correction data includes: receiving, at a mobile wireless device, at least one SPS correction provided by an SPS correction service of a plurality of SPS correction services; determining, at the mobile wireless device, a position estimate for the mobile wireless device based on the at least one SPS correction; and transmitting, from the mobile wireless device, a correction service message indicating: (1) a location corresponding to the position estimate for the mobile wireless device; (2) the SPS correction service; and (3) at least one correction service characteristic for each of at least one of the plurality of SPS correction services.

An example mobile wireless device includes: at least one memory; at least one transceiver; and at least one processor communicatively coupled to the at least one memory and the at least one transceiver and configured to: receive, via the at least one transceiver, at least one SPS correction provided by an SPS correction service of a plurality of SPS correction services; determine a position estimate for the mobile wireless device based on the at least one SPS correction; and transmit, via the at least one transceiver, a correction service message indicating: (1) a location corresponding to the position estimate for the mobile wireless device; (2) the SPS correction service; and (3) at least one correction service characteristic for each of at least one of the plurality of SPS correction services;

Another example mobile wireless device includes: means for receiving at least one SPS correction provided by an SPS correction service; means for determining a position estimate for the mobile wireless device based on the at least one SPS correction of a plurality of SPS correction services; and means for transmitting a correction service message indicating: (1) a location corresponding to the position estimate for the mobile wireless device; (2) the SPS correction service; and (3) at least one correction service characteristic for each of at least one of the plurality of SPS correction services.

Another example non-transitory, processor-readable storage medium includes processor-readable instructions to cause one or more processors of a mobile wireless device, for crowdsourcing satellite positioning system (SPS) correction data, to: receive at least one SPS correction provided by an SPS correction service of a plurality of SPS correction services; determine a position estimate for the mobile wireless device based on the at least one SPS correction; and transmit a correction service message indicating: (1) a location corresponding to the position estimate for the mobile wireless device; (2) the SPS correction service; and (3) at least one correction service characteristic for each of at least one of the plurality of SPS correction services.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a simplified diagram of an example mobile device.

FIG. 6 is a simplified view of multiple mobile devices, satellites, base stations, reference stations, and a server for acquiring and reporting crowdsourced information, and for determining disseminating satellite positioning signal correction information.

FIG. 7 is a simplified diagram of a geographic region, of different environments, divided into cells for respective satellite positioning signal correction information.

FIG. 8 is a processing and signal flow diagram of a method for determining a position estimate for a mobile device based on crowdsourced information.

FIG. 9 is a block flow diagram of a method of selecting a satellite positioning system correction service.

FIG. 10 is a block flow diagram of a method of crowdsourcing satellite positioning system correction information.

### DETAILED DESCRIPTION

Techniques are discussed herein for crowdsourcing and using Satellite Positioning System (SPS) correction information to select an SPS correction service, and using SPS correction information from the selected SPS correction service to determine a position estimate for an SPS receiver. For example, SPS receivers may receive SPS correction information (e.g., SPS signal corrections, satellite vehicle (SV) orbit error corrections, atmospheric error corrections, multipath corrections, etc.), and may receive and process (e.g., measure) SV signals using the corrections. The SPS receivers may report crowdsourced information (e.g., positioning accuracy, location, SPS correction service used, etc.). A server may collect the crowdsourced information, determine fine-tuned correction information (e.g., combined corrections for different SPS correction services, locations, positioning methods, and SPS signals). The server and/or an SPS receiver may use the fine-tuned correction information to select an SPS correction service (e.g., for a present or future location, for a positioning method, and for an SPS signal). The SPS receiver may use the selected SPS correction service to obtain SPS correction information, and use the SPS correction information to process received SV signals to determine a position estimate for the SPS receiver. Other configurations, however, may be used.

Items and/or techniques described herein may provide one or more of the following capabilities, as well as other capabilities not mentioned. Precise positioning accuracy may be maintained over the course of a path traveled by an SPS receiver. SPS corrections may be ignored (e.g., by not listening to an SPS correction service) while an SPS receiver is in a challenging environment, which may save battery power and/or processing resources. Cost savings may be realized for precise positioning, e.g., by selected a lower-monetary-cost SPS correction service (instead of a higher-monetary-cost SPS correction service) that provides sufficient positioning accuracy. Positioning accuracy degradation may be predicted, and proactive action taken to avoid the predicted degradation and maintain positioning accuracy. Switching between SPS correction services may be achieved without compromising positioning accuracy, e.g., based on advanced notice provided by a server. This may avoid using an SPS correction service that will not be able to deliver desired positioning accuracy and/or may avoid high reacquisition time and/or high convergence time. Robust and reliable positioning accuracy may be maintained opportunistically by maintaining a link with multiple SPS corrections services concurrently. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. In industrial applications, the location of a mobile device may be necessary for asset tracking, robotic control, and other kinematic operations which may require a precise location of an end effector. Existing positioning methods include methods based on measuring radio signals transmitted from a variety of devices or entities including satellite vehicles (SVs) and terrestrial radio sources in a wireless network such as base stations and access points. Stations in a wireless network may be configured to transmit reference signals to enable mobile device to perform positioning measurements. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, automobile, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® short-range wireless communication technology networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

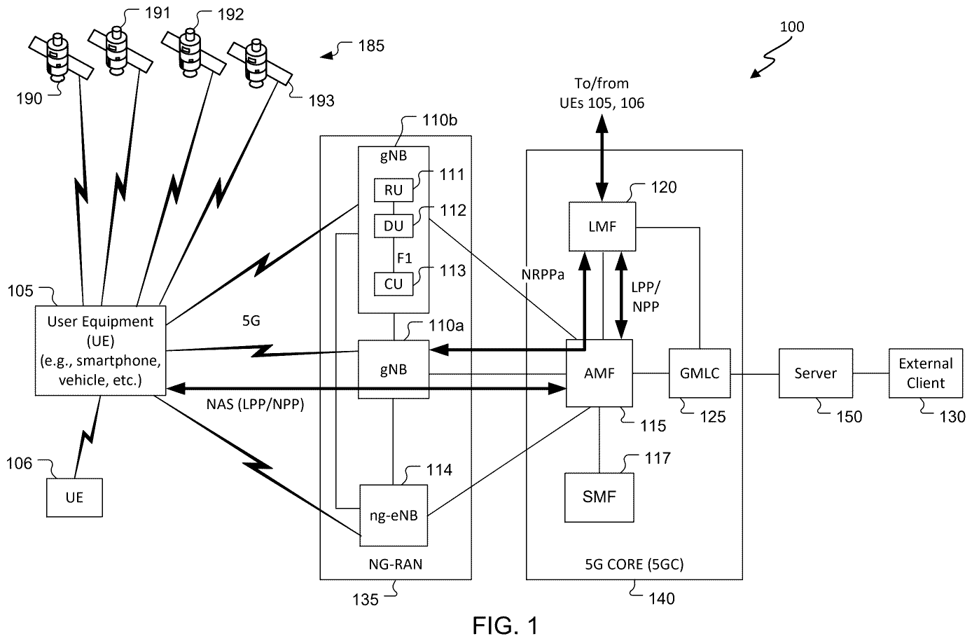

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi® short-range wireless communication technology, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V 2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some examples, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

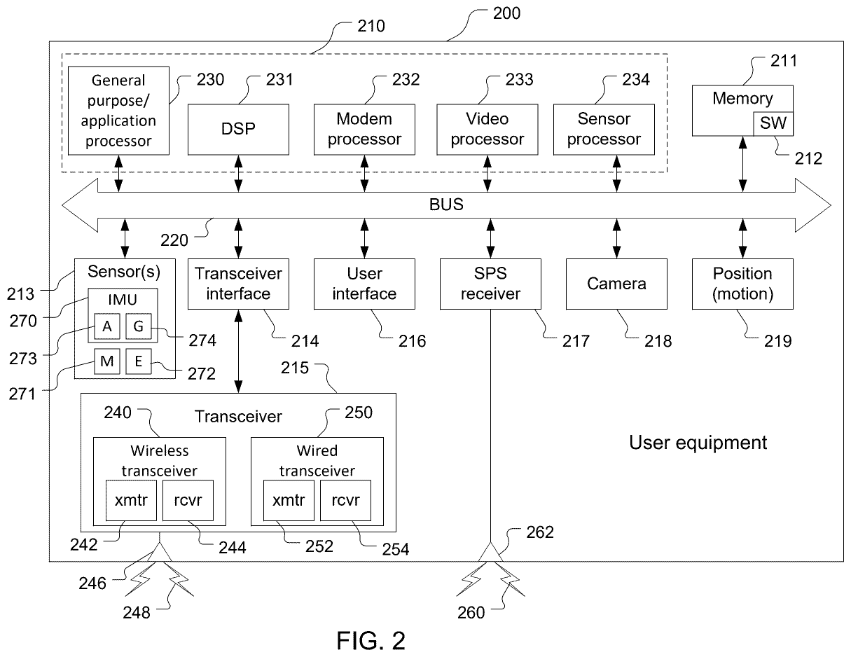

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise, for example, one or more accelerometers 273 (e.g., collectively responding to acceleration of the UE 200 in three dimensions) and/or one or more gyroscopes 274 (e.g., three-dimensional gyroscope(s)). The sensor(s) 213 may include the one or more magnetometers 271 (e.g., three-dimensional magnetometer(s)) to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

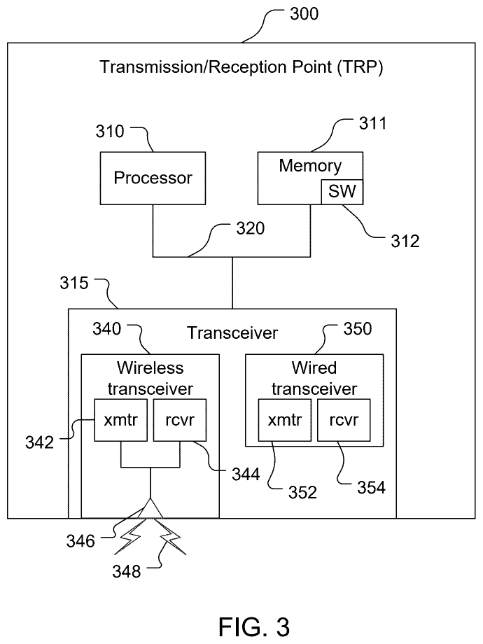

Referring also to FIG. 3, an example of a TRP 300 of the gNBs 110a, 110b and/or the ng-eNB 114 may comprise a computing platform including a processor 310, memory 311 including software (SW) 312, and a transceiver 315. Even if referred to in the singular, the processor 310 may include one or more processors, the transceiver 315 may include one or more transceivers (e.g., one or more transmitters and/or one or more receivers), and/or the memory 311 may include one or more memories. The processor 310, the memory 311, and the transceiver 315 may be communicatively coupled to each other by a bus 320 (which may be configured, e.g., for optical and/or electrical communication). One or more of the shown apparatus may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

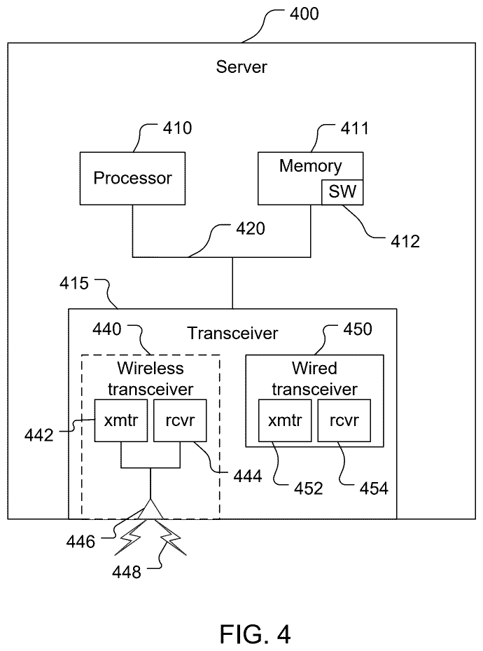

Referring also to FIG. 4, a server 400, of which the LMF 120 may be an example, may comprise a computing platform including a processor 410, memory 411 including software (SW) 412, and a transceiver 415. Even if referred to in the singular, the processor 410 may include one or more processors, the transceiver 415 may include one or more transceivers (e.g., one or more transmitters and/or one or more receivers), and/or the memory 411 may include one or more memories. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V 2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, and subtracting the UE_{Rx-Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource, or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

### Machine-Learning-Based Positioning

A SPS receiver may measure satellite vehicle signals (SV signals) to determine a location of the SPS receiver. For example, a UE may measure times of arrival of codes in SV signals and estimate a location, or provide measurement information to another device such as a location server that estimates a location, of the UE using the times of arrival. The location of the UE may be more-accurately determined using carrier-phase measurements of the SV signals and one or more positioning techniques such as RTK or PPP. Machine learning may be applied to carrier-phase positioning techniques, which may improve a rate of determining a position of the UE using a carrier-phase positioning technique and/or an accuracy of a position determined using a carrier-phase positioning technique.

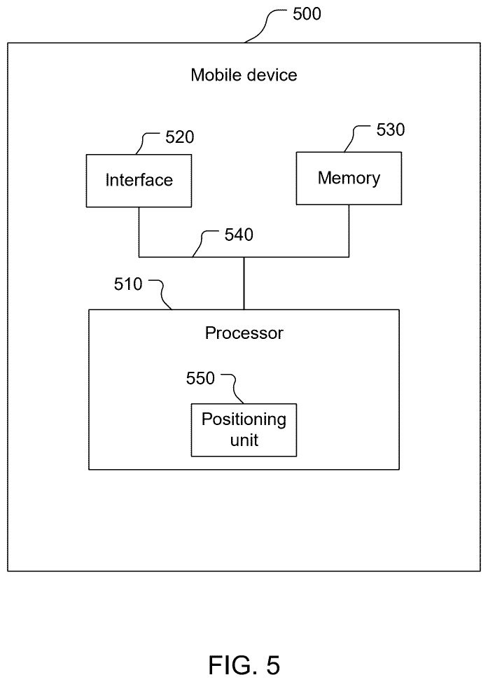

Referring to FIG. 5, with further reference to FIGS. 1-4, a mobile device 500 includes a processor 510, an interface 520, and a memory 530 communicatively coupled to each other by a bus 540. Even if referred to in the singular, the processor 510 may include one or more processors, the interface 520 may include one or more transceivers (e.g., one or more transmitters and/or one or more receivers), and the memory 530 may include one or more memories. The mobile device 500 may include the components shown in FIG. 5. The mobile device 500 may include one or more other components such as any of those shown in FIG. 2 such that the UE 200 may be an example of the mobile device 500. For example, the processor 510 may include one or more of the components of the processor 210. The interface 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the interface 520 may include the wired transmitter 252 and/or the wired receiver 254. The interface 520 may include the SPS receiver 217 and the SPS antenna 262. The memory 530 may be configured similarly to the memory 211, e.g., including software with processor-readable instructions configured to cause the processor 510 to perform functions. The mobile device may be a mobile wireless signaling device, being configured to transmit and/or receive one or more types of wireless signals, e.g., transmit and/or receiver PRS and/or receive SV signals.

The description herein may refer to the processor 510 performing a function, but this includes other implementations such as where the processor 510 executes software (stored in the memory 530) and/or firmware. The description herein may refer to the mobile device 500 performing a function as shorthand for one or more appropriate components (e.g., the processor 510 and the memory 530) of the mobile device 500 performing the function. The processor 510 (possibly in conjunction with the memory 530 and, as appropriate, the interface 520) includes a positioning unit 550. The configuration and functionality of the positioning unit 550 is discussed further herein, with mobile device 500 being configured to perform the functionality described as being performed by the positioning unit 550.

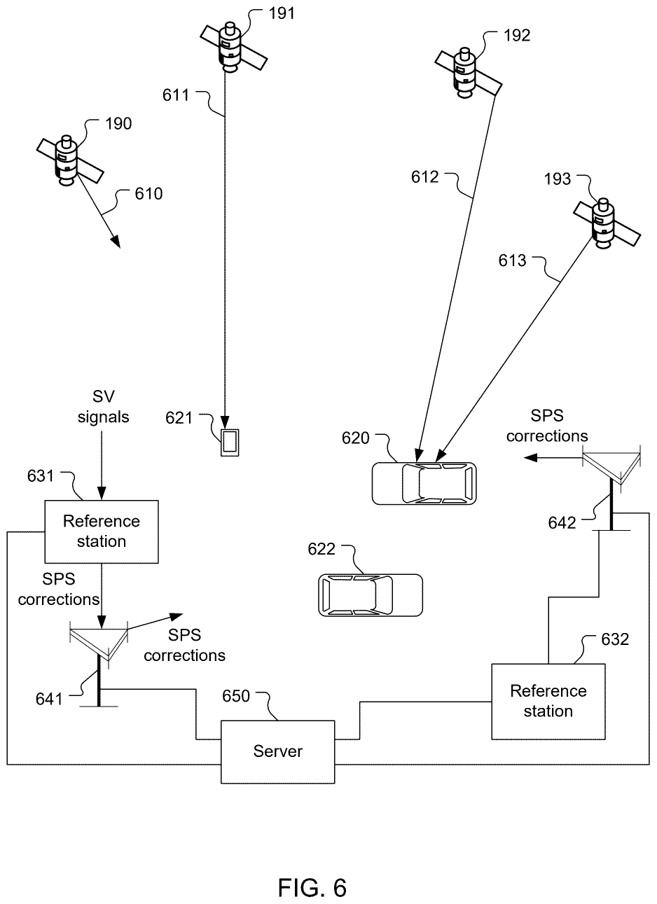

Referring also to FIG. 6, code-phase measurements and carrier-phase measurements may be used to determine location of a target UE with high precision. A carrier signal is produced by a satellite, e.g., the SV 191 (see also FIG. 1). The carrier signal (also called a carrier wave or a carrier) is a waveform used for modulation with a modulation signal to produce a new signal. Here, a PRN code signal (pseudorandom noise code signal) is used by the SV 191 to modulate the carrier signal to produce an SV signal (satellite vehicle signal), which comprises the PRN code signal and the carrier signal. The SVs 190, 191, 192, 193 may each transmit one or more respective SV signals, here SV signals 610, 611, 612, 613. Satellite signals from satellites in different satellite constellations may be received and measured by a respective SPS receiver in each of one or more mobile devices 620, 621, 622, e.g., to determine one or more respective position estimates. Thus, one or more of the SVs 190-193 may be in a different constellation than one or more other SVs of the SVs 190-193. Any of the signals 611-613 may be received by more than one SPS receiver, although this is not shown in FIG. 6 for sake of simplicity of the figure.

As shown, the SV 192 transmits the SV signal 612 to the mobile device 620 (in this example, being a vehicle). The mobile device 620 (e.g., the processor 510) may correlate the PRN code signal with a stored PRN code corresponding to the SV 192 to determine a time of arrival of the PRN code signal. An SPS receiver of the mobile device 620 may use the time of arrival to determine a time of travel between the SV 192 and the mobile device 620 to determine a distance between the SV 192 and the mobile device 620. Using multiple distances between the mobile device 620 and respective SVs 190-193, a position estimate may be determined for the mobile device 620 by trilateration. The distance determined using the PRN code signal typically has an error of at least several meters (e.g., 5 m, 10 m, or more), resulting in a position estimate with an error of about 1 meter or more. If, however, the mobile device 620 can obtain correction information for the SV signal 612, then the distances to SVs may be determined with less error (more accuracy), and thus the position estimate may be determined more accurately, e.g., with error on the order of decimeters or centimeters.

High-precision, real-time positioning is being driven, in part, by emerging mass-market applications such as autonomous driving and agricultural applications, which drive the desire for SPS corrections (or GNSS corrections). SPS receivers use external corrections to compensate for various imperfections called SPS errors (or GNSS errors) to achieve decimeter-level accuracy or even centimeter-level accuracy. RTK, PPP, and hybrid PPP-RTK are three main types of SPS correction methods for high-accuracy positioning. SPS errors include clock errors, orbit errors, satellite biases, atmospheric errors, and multipath errors. Clock errors are deviations from ideal of clocks of SVs. Orbit errors are deviations from expected orbits of SVs due, for example, to gravitational pull.

To overcome both satellite and atmospheric errors, one or more reference stations 631, 632 may estimate these errors and send SPS corrections to SPS receivers. The SPS corrections may be provided to SPS receivers in any of a variety of ways including third-party/private correction services, satellite over-the-air (OTA) correction services, and/or cellular correction services. Third-party/private correction services may deliver SPS corrections via the Internet (e.g., using NTRIP (Networked Transport of RTCM (Radio Technical Commission for Maritime Services) via Interenet Protocol)). Satellite OTA correction services may be free services providing SSR (Space State Representation) corrections, e.g., for Galileo (for Europe), QZSS (for Japan), and/or Beidou (for China). Cellular correction services may provide SPS corrections through terrestrial network, e.g., using LTE Positioning Protocol (LPP).

Ensuring consistent, high-accuracy positioning is challenging, particularly in mobile applications. Precise positioning often relies on high-frequency, real-time corrections for error mitigation. This makes precise positioning sensitive to correction outages as an interruption in continuous wireless connections may prevent a high update rate and timely reception of correction data. Precise positioning accuracy may be lost due to one or more of a variety of factors including outage in correction reception, reference station handover/swapping, poor-quality corrections, environmental changes, etc. Outages in correction reception may be due, for example, to server issues and/or mobile service/connectivity issues. Because SPS corrections may be invalid quickly, e.g., after one second, frequent updates may be essential. Reference station handover/swapping is a common issue in dynamic/mobile use cases. Poor quality corrections may be due, for example, to unmodelled errors and/or high latency. Further, it may be difficult to predict when high-accuracy positioning, e.g., decimeter-level positioning or centimeter-level positioning, may be compromised. If sub-meter positioning accuracy is lost, reacquiring sub-meter positioning accuracy may be difficult, especially within time constraints depending on the application (e.g., autonomous driving). For example, high convergence times (e.g., tens of seconds, minutes, or even tens of minutes) and/or long initialization times can delay regaining sub-meter positioning accuracy.

Different types of correction services have different advantages and disadvantages. For example, different types of correction services may provide different accuracies, may provide different types of corrections, and/or may have different monetary costs, different availabilities, different reliabilities, different applicability to different environments, and/or different corresponding power consumptions. Also or alternatively, different types of corrections services may have different convergence times (which may affect reacquisition time if corrections are lost, e.g., due to an outage), different data rate/bandwidth requirements (e.g., 0.5 kbps to 2.0 kbps), different supported signals (e.g., corrections for different SPS such as GPS, GAL, BDS, and/or for different frequency bands, e.g., L1, L5, L2), different sensitivities, and/or different coverages (e.g., global vs. regional). For example, for decoding OTA corrections from a satellite, there may be a minimum sensitivity requirement for the SPS receiver, e.g., >30 dBHz, while for other correction service types there may be no such minimum decode sensitivity.

Positioning accuracy is variable and may depend on the correction method, location, reference station density, quality of error modelling, and/or different initialization times, etc. An RTK-based correction method may provide better accuracy than PPP or PPP-RTK, but may require a high reference station density. Positioning accuracy may be location dependent, e.g., with region-specific SPSes providing better accuracy for respective regions (e.g., China for Beidou, Europe for Galileo). Positioning accuracy may thus vary between SPS service providers and/or correction service providers. SPS service providers may have different modeling in different regions (e.g., better modeling in a home country). Correction service providers may use different correction methods in different regions, e.g., RTK in one or more regions and PPP in one or more other regions.

Positioning accuracy may vary based on the types of corrections provided. Not all correction service providers provide SPS corrections for all types of SPS errors (e.g., clock errors, orbit errors, satellite biases, atmospheric errors, and multipath errors).

Different correction services may have different monetary costs. For example, satellite OTA corrections may be provided for free but third-party/private correction services and/or cellular correction services may charge a fee (e.g., a subscription fee, or a fee per correction(s) provided). Further, RTK corrections are typically more expensive than PPP corrections or PPP-RTK corrections.

Different correction services may have different availabilities. For example, availability of corrections for RTK and PPP-RTK may depend on terrestrial infrastructure (e.g., quantity and/or density of reference stations near a desired location).

Third-party/private correction services and/or cellular correction services may depend on Internet/data connections to mobile devices. Therefore, third-party/private correction services may be subject to connectivity to the mobile devices, whereas satellite OTA corrections may be more available (e.g., absent an SPS receiver being indoors or in a canyon (urban or natural)).

Different correction services may have different reliabilities. For example, third-party/private service providers may be less reliable than satellite-based and/or cellular-based correction service providers.

Different correction services may have different applicability to different environments. For example, correction services for PPP may not help significantly in achieving sub-meter positioning accuracy in dense urban/multipath environments.

Different correction services may have different corresponding power consumptions. For example, decoding OTA corrections, especially frequently, may use more power than decoding corrections from third-party/private service providers and/or cellular-based service providers that are delivered over the Internet and/or via a cellular network. For OTA corrections, a terrestrial-based control station (e.g., one or more of the reference stations 631, 632) may determine one or more SPS corrections, upload the corrections to one or more SVs, and the SV(s) may transmit the SPS correction(s) to the SPS receiver(s). One or more of the reference stations 631, 632 may be dedicated to specific correction service provider. One or more of the reference stations 631, 632 may be shared by multiple correction service providers.

Each of the SPS receivers in the mobile devices 620-622 may be able to collect and report crowdsourced information to a server 650, e.g., via one or more of the base stations 641, 642. The server 650 is an example of the server 400. The server 650 may be communicatively coupled to one or more of the base stations 641, 642 and/or to one or more of the reference stations 631, 632, e.g., to receive crowdsourced information from the SPS receivers in the mobile devices 620-622 and/or correction services information (e.g., one or more SPS corrections) from one or more of the reference stations 631, 632. The crowdsourced information from the SPS receivers in the mobile devices 620-622 may comprise, for example, correction services information, position information, and environmental information.

Each of the SPS receivers in the mobile devices 620-622 may provide a variety of correction services information for one or more correction services for one or more locations to which the mobile device 620-622 travels. For example, the correction services information may include a correction method (e.g., whether the correction(s) used were for RTK, PPP, and/or PPP-RTK positioning). The correction services information may include an accuracy estimate, e.g., whether a position estimate determined using a particular positioning method, with provided correction(s), will have a centimeter-level accuracy or a decimeter-level accuracy or other level of accuracy. The correction services information may include an availability of a correction service. The availability may be for a particular type of correction service (e.g., OTA, third-party/private, cellular) and may be whether a correction service is available from a particular service provider (e.g., third-party/private from Company A (e.g., Trimble)). The correction services information may include cost, e.g., monetary cost, of a correction service (e.g., service type and provider, if applicable). The correction services information may include a convergence time associated with the correction service (e.g., the service type, the provider (if applicable), and the correction method). The correction services information may include a correction quality (e.g., an indication of high or low quality based on reference station density). For RTK, a station spacing up to 50 km may correspond to high correction quality and above 50 km may correspond to low correction quality. For PPP, station spacing up to 1,000 km may correspond to high correction quality and spacing above 1,000 km may correspond to low correction quality. For PPP-RTK, station spacing up to 200 km may correspond to high correction quality and spacing above 200 km may correspond to low correction quality. The correction services information may include correction service reliability (e.g., with accuracy of a desired level being consistently maintained corresponding to high reliability and otherwise corresponding to low reliability). The correction services information may include a data rate for providing the SPS correction(s). The correction services information may include a coverage area for (each of) the SPS correction(s) provided. The correction services information may include which SV signals are supported, i.e., for which SPS signal(s) one or more corrections are available. The SPS signal(s) may be specified, e.g., by constellation (e.g., Galileo, GPS, GNSS, Beidou) and/or frequency (e.g., L1, L5, L2). The correction services information may include a satellite ID corresponding to each correction, e.g., SV PRN for each SV providing one or more OTA corrections. The correction services information may include the types of corrections available (e.g., correction(s) for GNSS errors). The correction services information may include a receiver sensitivity (for OTA), e.g., a minimum receiver sensitivity for a receiver to receive and decode the SPS correction (for an associated geographic area). The correction services information may include an estimate of power consumption for decoding the SPS correction(s).

The position information of the crowdsourced information may be determined in a variety of ways. For example, a position estimate may be determined from terrestrial PRS using trilateration. As another example, a position estimate may be determined using E-CID. As another example, a position estimate may be determined using SPS signals and one or more SPS corrections provided by the server 650 (e.g., based on previously crowdsourced information).

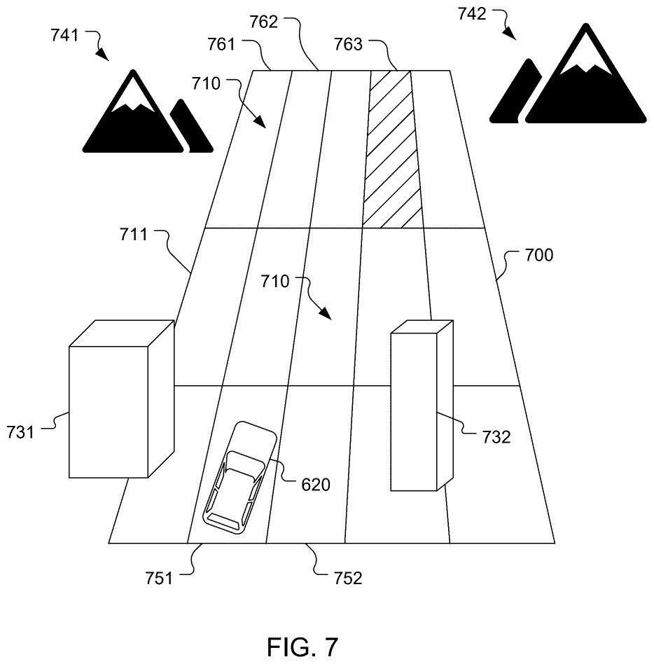

As shown in FIG. 7, correction services information may be associated with a geographic region, e.g., a grid cell 710 within a grid 700. For example, the mobile device 620-622 may associate a position estimate with one of the grid cells 710 and report the grid cell in association with the respective correction services information. As another example, the server 650 may determine the grid cell 710 that corresponds to the position estimate reported by the mobile device 620-622 and/or determined by the server 650, e.g., from positioning signal measurement(s) reported by the mobile device 620-622.

The environmental information of the crowdsourced information may indicate a variety of environmental conditions. For example, the environment may be described in terms of being open sky (e.g., for a grid cell 711), or as a canyon (e.g., as a canyon generally, or as an urban canyon such as for grid cells 751, 752 between buildings 731, 732, or as a natural canyon such as for grid cells 761, 762 between mountains 741, 742). The mobile device 620, which is an example of the mobile device 500, may determine the environmental information using one or more cameras (e.g., the camera 218) and/or by analyzing received SPS signals and/or determining failure to receive expected SPS signals (e.g., based on a location estimate for the mobile device 620 and ephemeris data of SVs).

Any of the SPS receivers in the mobile devices 620-622 may report the crowdsourced information periodically, aperiodically, and/or semi-persistently. For example, the mobile device 620 may report crowdsourced information at regular intervals, e.g., every minute. As another example, the mobile device 620 may report crowdsourced information aperiodically, e.g., in response to positioning accuracy changing from being within an acceptable accuracy (e.g., centimeter-level accuracy or decimeter-level accuracy) to being an unacceptable accuracy (e.g., above decimeter-level accuracy, e.g., being meter-level accuracy). As another example, the mobile device 620 may report crowdsourced information semi-persistently, e.g., in response to a change in positioning accuracy from acceptable accuracy to unacceptable accuracy, reporting crowdsourced information every minute for 20 minutes, or every minute until the positioning accuracy is acceptable again.

The server 650 may collect the crowdsourced information from the SPS receivers in the mobile devices 620-622 into crowdsourced information, and process and provide the crowdsourced information. The server 650, e.g., the processor 410 (possibly in combination with the memory 411), may run machine learning on the crowdsourced information to fine tune the information (e.g., determine the accuracy information based on multiple reported accuracies, etc.). The server 650, e.g., the processor 410 (possibly in combination with the memory 411) in combination with the transceiver 415 (e.g., the wired transmitter 452 and/or the wireless transmitter 442 in combination with the antenna 446) may transmit the fine-tuned information to one or more SPS receivers. The server 650 may transmit the fine-tuned information via one or more base stations for the mobile device 620 to use at a present location, e.g., a present grid cell 751, of the mobile device 620 and/or a future location, e.g., a future grid cell 763, of the mobile device 620.

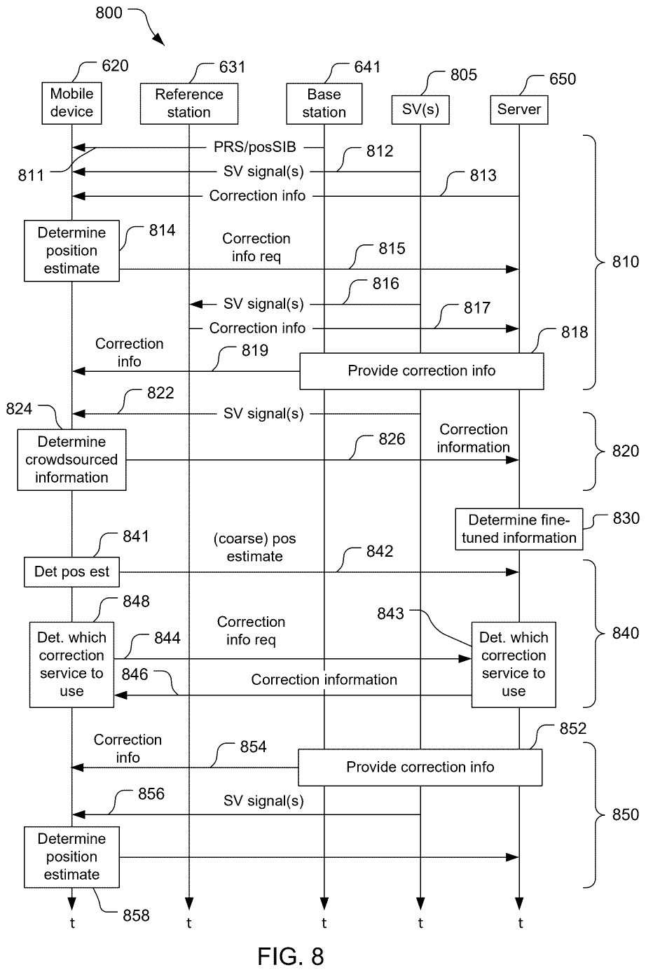

Referring also to FIG. 8, a signal and processing flow 800 for determining a position estimate for the mobile device 620 based on crowdsourced information includes stages shown. The flow 800 is an example flow and not limiting. The flow 800 may be altered, e.g., by having one or more messages and/or one or more stages added, removed, rearranged, combined, performed concurrently, and/or having one or more messages and/or one or more stages split into multiple messages and/or stages. A single SPS receiver, a single reference station, a single base station, and a single server are discussed with respect to FIG. 8 for simplicity of the discussion, but the discussion of FIG. 8 is applicable to multiple SPS receivers, multiple reference stations, multiple base stations, and multiple servers.

At stage 810, the mobile device 620 obtains correction information for a present or future location of the mobile device 620. The mobile device 620 may receive PRS/posSIB 811 (System Information Block) and/or one or more SV signals 812 from one or more SVs 805, and possibly SPS correction information 813. The posSIB carriers RTK corrections. At sub-stage 814, the mobile device 620 may determine a position estimate of the mobile device 620 using the PRS 811 and/or the SV signal(s) 812 (and possibly the SPS correction information 813). The mobile device 620 may determine an estimate of a future position of the mobile device 620 (e.g., based on multiple position estimates and a trajectory determined therefrom and/or determined from other information (e.g., a destination programmed into a navigation application and a route indicated by the navigation application)). Based on the determined estimate of the present and/or the future position of the mobile device 620, the mobile device 620 may transmit a correction information request 815 to the server 650 requesting SPS correction information for the present and/or future location of the mobile device 620. The reference station 631 may receive and measure one or more SV signals 816, determine SPS correction information from the measured SV signal(s), and provide SPS correction information 817 to the server 650 for a location of the reference station 631. At sub-stage 818, one or more correction services may provide, via the server 650, the SV(s) 805, and/or the base station 641, SPS correction information 819 to the mobile device 620 for the requested (present and/or future) location (e.g., for the cell 751 and/or the cell 763) of the mobile device 620.

At stage 820, the mobile device 620 may collect and report crowdsourced information, e.g., for each source of corrections (e.g., possible or from which at least one correction is received). The mobile device 620 may receive one or more SV signals 822 from the SV(s) 805. As sub-stage 824, the mobile device 620, e.g., the positioning unit 550, may measure the SV signal(s) 822 and determine crowdsourced information, e.g., a position estimate (using the correction information 819, e.g., one or more SPS corrections), positioning accuracy (by using the SV signal measurements to determine a position estimate), correction service availability, correction method, cost of correction service, convergence time, quality of correction(s), service reliability, data rate, coverage, supported signals, satellite ID, types of correction, receiver sensitivity, power consumption estimate, and/or environmental information, etc. The mobile device 620 may report crowdsourced information 826 to the server 650. The mobile device 620 may collect and/or report the crowdsourced information 826 aperiodically, semi-persistently, or periodically. The crowdsourced information 826 may indicate a location corresponding to the position estimate for the mobile device 620 (e.g., the estimate or a grid cell including the position estimate), may indicate the SPS correction service whose SPS correction(s) were used to determine the position estimate, and may indicate at least one correction service characteristic corresponding to at least one of the SPS correction service, the at least one SPS correction, and the position estimate for the mobile wireless signaling device.

At stage 830, the server 650 may determine fine-tuned SPS correction information from multiple reports of the crowdsourced information 826. For example, the server 650 may collect the crowdsourced information 826 from multiple SPS receivers for the same locations and same correction services. The server 650 may combine information from multiple sources for the same correction service to determine the correction(s) for that service, and do this for each correction service. The server 650 may determine fine-tuned SPS correction information from the collected crowdsourced information, e.g., running machine learning to determine fine-tuned correction information for multiple correction services, for multiple locations (e.g., grid cells), for multiple correction methods, for multiple SPS signals, etc. For example, for the same correction service, correction method, and coverage area, the server 650 may determine the availability, cost, convergence time, etc. By doing this for multiple correction services, the server 650 may determine fine-tuned correction information for the same correction method, coverage area, etc. for multiple correction services. For example, the server 650 may try to determine the best corrections for each correction service.

At stage 840, the server 650 and/or the mobile device 620 may determine which correction service to use, e.g., for a desired geographic location. For example, at sub-stage 841, the mobile device 620 may determine a coarse position estimate of the mobile device 620, e.g., using E-CID and/or trilateration using PRS and/or SV signals (e.g., code phase positioning). The coarse position estimate may be for a present location of the mobile device 620 or a future (predicted) location of the mobile device 620. The mobile device 620 may transmit a position estimate message 842 with the coarse position estimate of the mobile device 620. At sub-stage 843, the server 650, e.g., the processor 410 (possibly in combination with the memory 411, e.g., the software 412), may use the fine-tuned correction information to determine which of the correction services that are available for a desired location (corresponding to the coarse position estimate) best meets desired operation (e.g., a desired SPS correction service characteristic such as cost, or a combination of SPS correction service characteristics such as cost, supported signals, reliability, etc.). The combination may be a weighted combination, with different characteristics having different weightings. The correction service may be determined based on, e.g., accuracy, availability, power budget, cost, data rate, convergence time, environmental features, receiver sensitivity, quality, and/or reliability. A decision may be made for the mobile device 620 not to listen to an SPS correction service temporarily, e.g., if an environment of the desired location is challenging (e.g., has heavy multipath) and SPS corrections may not be useful, or if the sensitivity of the mobile device 620 does not meet a minimum sensitivity requirement, or if precise positioning is unnecessary, e.g., not required by an application that requests the position estimate of the mobile device 620. The server 650 may predict a degradation in positioning accuracy (e.g., based on crowdsourced SPS correction information and a predicted future location of the mobile device 620) and determine an SPS correction service to use in order to take proactive “corrective” action to help maintain positioning accuracy instead of waiting for positioning accuracy to decline, then changing the SPS correction service used. The fine-tuned correction information may include information as to which of the SV(s) 805 provide OTA corrections as not every SV may transmit correction information.

At sub-stage 848, the mobile device 620 may determine, e.g., similarly to sub-stage 843, which correction service to use based on fine-tuned information provided by the server 650 in a correction information message 846 in response to a correction information request 844 sent by the mobile device 620 to the server 650. Alternatively, the mobile device 620 may make the decision at sub-stage 848 by reading an instruction from the server 650 in the correction information message 846 indicating which SPS correction service to use. For example, an Internet of Things (IoT) device may receive an instruction as to which SPS correction service to use, without the IoT device analyzing the fine-tuned correction information to determine which SPS correction service to use, e.g., because the IoT may have very limited battery power, memory, computational capability, and/or intelligence. The selection of an SPS correction service may be made in order to maintain consistent sub-meter accuracy during travel by the mobile device 620. The server 650 may comprise multiple servers, e.g., one server that performs stage 830 (collecting and analyzing crowdsourced information), and another server that performs sub-stage 843 to determine which SPS correction service to use.

The selection of an SPS correction service may involve switching from one SPS correction service currently being used to another SPS correction service. For example, a different SPS correction service may be selected based on a presently-used SPS correction service becoming unavailable, or based on the presently-used SPS correction service being expected to lose sub-meter level accuracy (e.g., due to poor quality of correction(s) or outage(s) or reference station handover) along a route of the mobile device 620.

The mobile device 620 may opportunistically maintain a link with multiple SPS correction services. For example, for high-priority applications (e.g., autonomous driving) and/or based on a request for a consistency check (e.g., included in the correction information request 844 or internally conveyed within the mobile device at sub-stage 848) between SPS correction services, and/or if accuracy degradation is expected, then the mobile device 620 may concurrently link with, and receive SPS corrections from, multiple SPS correction services. In this case, the correction information message 846 (and/or an internal indication in the mobile device 620) may indicate multiple SPS correction services available for use by the mobile device 620 at the coarse location of the mobile device 620. Links to multiple SPS correction services may be maintained, for example, temporarily before and up to an expected outage from one of the SPS correction services.

At stage 850, the mobile device 620 may determine a position estimate for the mobile device 620 using the SPS correction service(s) selected at stage 840. At sub-stage 852, the mobile device 620 may receive SPS correction information 854, e.g., one or more SPS corrections from the SPS correction service(s) selected at stage 840, even if the mobile device 620 received fine-tuned correction information at stage 830 because SPS corrections have short time periods of validity. The mobile device 620 may receive SV signals 856. At sub-stage 858, the mobile device 620 may process the SV signals 856 using the SPS correction information to determine a position estimate for the mobile device 620.

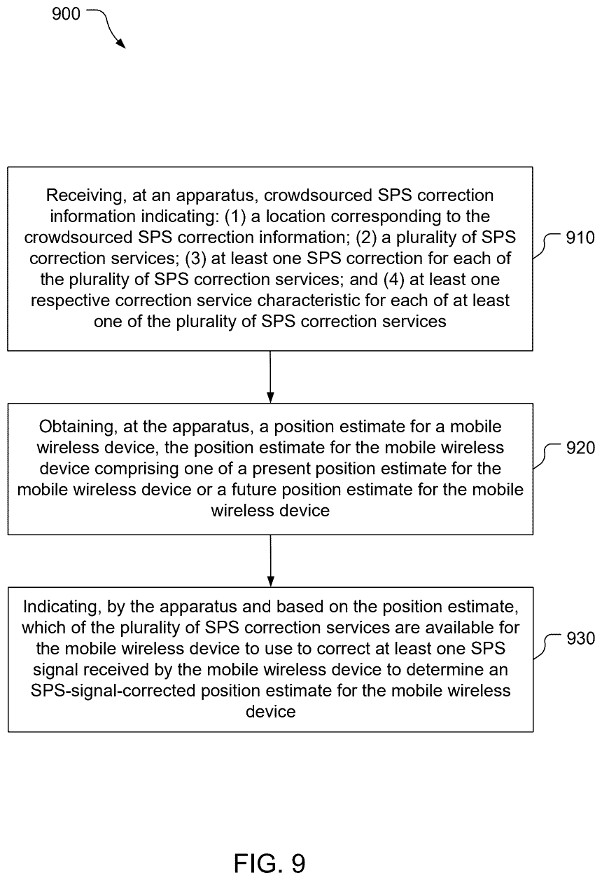

Referring to FIG. 9, with further reference to FIGS. 1-8, a method 900 of selecting an SPS correction service includes the stages shown. The method 900 is, however, an example only and not limiting. The method 900 may be altered, e.g., by having stages added, removed, rearranged, combined, performed concurrently, and/or having single stages split into multiple stages.

At stage 910, the method 900 includes receiving, at an apparatus, crowdsourced SPS correction information indicating: (1) a location corresponding to the crowdsourced SPS correction information; (2) a plurality of SPS correction services; (3) at least one SPS correction for each of the plurality of SPS correction services; and (4) at least one respective correction service characteristic for each of at least one of the plurality of SPS correction services. For example, at stage 820 the server 650 receives the correction information 826 from the mobile device 620 and possibly one or more other SPS receivers. The processor 410, possibly in combination with the memory 411, in combination with the wired receiver 454 and/or the wireless receiver 444 and the antenna 446 may comprise means for receiving the crowdsourced SPS correction information. As another example, at stage 840 the mobile device 620 may receive the correction information message 846 including fine-tuned crowdsourced SPS correction information. The processor 510, possibly in combination with the memory 530, in combination with interface 520 (e.g., the wireless receiver 244 and the antenna 246) may comprise means for receiving the crowdsourced SPS correction information.

At stage 920, the method 900 includes obtaining, at the apparatus, a position estimate for a mobile wireless device, the position estimate for the mobile wireless device comprising one of a present position estimate for the mobile wireless device or a future position estimate for the mobile wireless device. For example, at stage 840 the server 650 may receive the position estimate message 842 indicating the coarse position estimate of a present or future location of the mobile device 620. The processor 410, possibly in combination with the memory 411, in combination with the wired receiver 454 and/or the wireless receiver 444 and the antenna 446 may comprise means for receiving obtaining the position estimate for the mobile wireless signaling device. Alternatively, at sub-stage 841 the mobile device 620, e.g., the positioning unit 550, may determine a (coarse) position estimate for the mobile device 620. The processor 510, possibly in combination with the memory 530, in combination with interface 520 (e.g., the wireless receiver 244 and the antenna 246, and/or the SPS receiver 217) may comprise means for receiving the crowdsourced SPS correction information.

At stage 930, the method 900 includes indicating, by the apparatus and based on the position estimate, which of the plurality of SPS correction services are available for the mobile wireless device to use to correct at least one SPS signal received by the mobile wireless device to determine an SPS-signal-corrected position estimate for the mobile wireless device. For example, at sub-stage 843 the server 650 may transmit the correction information message 846 indicating which SPS correction service(s) are available for the mobile device 620 to use (e.g., which of SPS corrections service(s) to use) at the present or future location of the mobile device 620. The processor 410, possibly in combination with the memory 411, in combination with the wired transmitter 452 and/or the wireless transmitter 442 and the antenna 446 may comprise means for indicating which of the SPS correction services are available for the mobile device 620 to use. Alternatively, at sub-stage 848 the mobile device 620 may internally indicate which SPS correction service(s) are available for the mobile device 620 to use (e.g., which of SPS corrections service(s) to use) at the present or future location of the mobile device 620. The processor(s) 510, possibly in combination with the memory 530, may comprise means for indicating which of the SPS correction services are available for the mobile device 620 to use.

Implementations of the method 900 may include one or more of the following features. In an example implementation, indicating which of the plurality of SPS correction services are available for the mobile wireless device to use comprises indicating at least two of the plurality of SPS correction services for the mobile wireless device to use. For example, multiple SPS correction services may be indicated internally to the mobile device 620 and/or in the correction information message 846 for use if there is an expected outage or degradation in positioning accuracy. In a further example implementation, indicating at least two of the plurality of SPS correction services is based on a request for the mobile wireless device to perform a consistency check between SPS correction services. In another further example implementation, the position estimate for the mobile wireless device is the future position estimate for the mobile wireless device, and wherein indicating at least two of the plurality of SPS correction services is based on an expected loss of availability, at the future position estimate for the mobile wireless device, of one of the at least two of the plurality of SPS correction services.

Also or alternatively, implementations of the method 900 may include one or more of the following features. In an example implementation, the apparatus is a server (e.g., the server 650). In another example implementation, the apparatus is the mobile wireless signaling device (e.g., the mobile device 620). In another example implementation, the method 900 includes determining which of the plurality of SPS correction services for the mobile wireless device to use based on at least one of a positioning accuracy corresponding to at least one of the plurality of SPS correction services, a monetary cost of at least one of the plurality of SPS correction services, a data rate corresponding to at least one of the plurality of SPS correction services, a receiver sensitivity of the mobile wireless device and a receiver sensitivity requirement corresponding to at least one of the plurality of SPS correction services, a power budget of the mobile wireless device and a power requirement corresponding to at least one of the plurality of SPS correction services, a reliability of at least one of the plurality of SPS correction services, at least one quality of the at least one SPS correction, and at least one convergence time corresponding to the at least one SPS correction. The processor(s) 510, possibly in combination with the memory 530, may comprise means for determining which of the plurality of SPS correction services for the mobile wireless signaling device to use while at the position estimate.

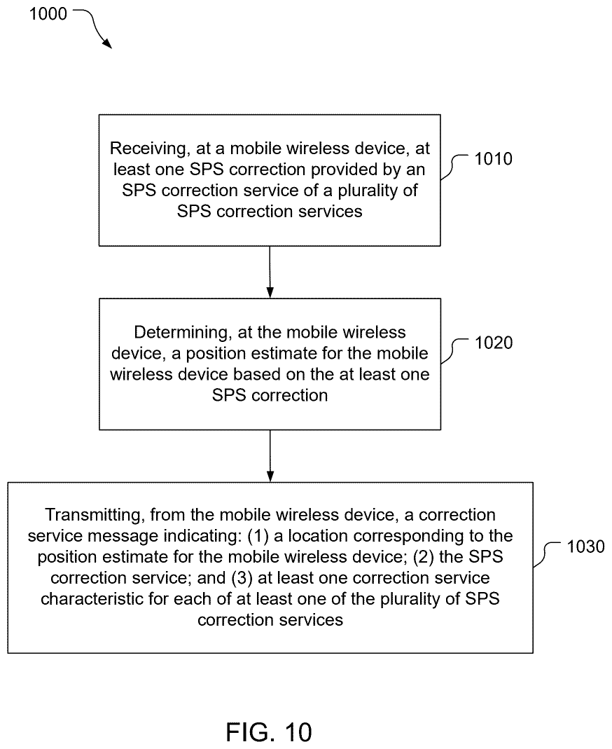

Referring to FIG. 10, with further reference to FIGS. 1-8, a method 1000 of crowdsourcing SPS correction information includes the stages shown. The method 1000 is, however, an example only and not limiting. The method 1000 may be altered, e.g., by having stages added, removed, rearranged, combined, performed concurrently, and/or having single stages split into multiple stages.

At stage 1010, the method 1000 includes receiving, at a mobile wireless device, at least one SPS correction provided by an SPS correction service of a plurality of SPS correction services. For example, at stage 810 the mobile device 620 may receive the correction information 819 from the server 650 (e.g., directly or via the base station 641), the SV(s) 805, or via the Internet from a third-party/private SPS correction service via the base station 641. The processor 510, possibly in combination with the memory 530, in combination with interface 520 (e.g., the wireless receiver 244 and the antenna 246, and/or the SPS receiver 217) may comprise means for receiving at least one SPS correction.

At stage 1020, the method 1000 includes determining, at the mobile wireless device, a position estimate for the mobile wireless device based on the at least one SPS correction. For example, at sub-stage 824 the mobile device 620, e.g., the positioning unit 550, may determine a position estimate using the correction information. The processor 510, possibly in combination with the memory 530, may comprise means for determining the position estimate.

At stage 1030, the method 1000 includes transmitting, from the mobile wireless device, a correction service message indicating: (1) a location corresponding to the position estimate for the mobile wireless device; (2) the SPS correction service; and (3) at least one correction service characteristic for each of at least one of the plurality of SPS correction services. For example, at sub-stage 824 the mobile device may transmit the correction information 826 to the server 650. The processor 510, possibly in combination with the memory 530, in combination with interface 520 (e.g., the wireless transmitter 242 and the antenna 246) may comprise means for transmitting the correction service message.

Implementations of the method 1000 may include one or more of the following features. In an example implementation, transmitting the correction service message comprises at least one of: transmitting the correction service message periodically; transmitting the correction service message aperiodically in response to accuracy of the position estimate dropping below a threshold positioning accuracy; and transmitting the correction service message semi-persistently in response to accuracy of the position estimate dropping below the threshold positioning accuracy. In another example implementation, the at least one correction service characteristic corresponds to the SPS correction service and is at least one of: whether the SPS correction service is available; cost of the SPS correction service; reliability of the SPS correction service; data rate of the SPS correction service; geographic coverage of the SPS correction service; satellite identifier; and minimum receiver sensitivity. In another example implementation, the at least one correction service characteristic corresponds to the at least one SPS correction and is at least one of: correction quality; signal type for the at least one SPS correction; correction type including at least one of clock error, orbit error, satellite bias, atmospheric error, and multipath; and a power consumption estimate for decoding the at least one SPS correction. In another example implementation, the at least one correction service characteristic corresponds to the position estimate for the mobile wireless device and is at least one of: a positioning method; a position estimate accuracy; and a positioning method convergence time. In another example implementation, the correction service message further indicates an environment corresponding to the position estimate for the mobile signaling device. For example, the correction information 826 may indicate whether the location corresponding to the position estimate is open sky or a canyon (whether natural or urban, and may indicate the type of canyon).

### Implementation Examples

Implementation examples are provided in the following numbered clauses.

Clause 1. 1. A method of selecting a satellite positioning system (SPS) correction service, the method comprising:
receiving, at an apparatus, crowdsourced SPS correction information indicating: (1) a location corresponding to the crowdsourced SPS correction information; (2) a plurality of SPS correction services; (3) at least one SPS correction for each of the plurality of SPS correction services; and (4) at least one respective correction service characteristic for each of at least one of the plurality of SPS correction services;
obtaining, at the apparatus, a position estimate for a mobile wireless device, the position estimate for the mobile wireless device comprising one of a present position estimate for the mobile wireless device or a future position estimate for the mobile wireless device; and
indicating, by the apparatus and based on the position estimate, which of the plurality of SPS correction services are available for the mobile wireless device to use to correct at least one SPS signal received by the mobile wireless device to determine an SPS-signal-corrected position estimate for the mobile wireless device.

Clause 2. The method of claim 1, wherein indicating which of the plurality of SPS correction services are available for the mobile wireless device to use comprises indicating at least two of the plurality of SPS correction services for the mobile wireless device to use.

Clause 3. The method of claim 2, wherein indicating at least two of the plurality of SPS correction services is based on a request for the mobile wireless device to perform a consistency check between SPS correction services.

Clause 4. The method of claim 2, wherein the position estimate for the mobile wireless device is the future position estimate for the mobile wireless device, and wherein indicating at least two of the plurality of SPS correction services is based on an expected loss of availability, at the future position estimate for the mobile wireless device, of one of the at least two of the plurality of SPS correction services.

Clause 5. The method of claim 1, wherein the apparatus is a server.

Clause 6. The method of claim 1, wherein the apparatus is the mobile wireless device.

Clause 7. The method of claim 1, further comprising determining which of the plurality of SPS correction services for the mobile wireless device to use based on at least one of a positioning accuracy corresponding to at least one of the plurality of SPS correction services, a monetary cost of at least one of the plurality of SPS correction services, a data rate corresponding to at least one of the plurality of SPS correction services, a receiver sensitivity of the mobile wireless device and a receiver sensitivity requirement corresponding to at least one of the plurality of SPS correction services, a power budget of the mobile wireless device and a power requirement corresponding to at least one of the plurality of SPS correction services, a reliability of at least one of the plurality of SPS correction services, at least one quality of the at least one SPS correction, and at least one convergence time corresponding to the at least one SPS correction.

Clause 8. An apparatus comprising:
at least one memory;
at least one transceiver; and
at least one processor communicatively coupled to the at least one memory and the at least one transceiver and configured to:
   receive, via the at least one transceiver, crowdsourced SPS correction information indicating: (1) a location corresponding to the crowdsourced SPS correction information; (2) a plurality of SPS correction services; (3) at least one SPS correction for each of the plurality of SPS correction services; and (4) at least one respective correction service characteristic for each of at least one of the plurality of SPS correction services;
   obtain a position estimate for a mobile wireless device, the position estimate for the mobile wireless device comprising one of a present position estimate for the mobile wireless device or a future position estimate for the mobile wireless device; and
   indicate, based on the position estimate, which of the plurality of SPS correction services are available for the mobile wireless device to use to correct at least one SPS signal received by the mobile wireless device to determine an SPS-signal-corrected position estimate for the mobile wireless device.

Clause 9. The apparatus of claim 8, wherein to indicate which of the plurality of SPS correction services are available for the mobile wireless device to use the at least one processor is configured to indicate at least two of the plurality of SPS correction services for the mobile wireless device to use.

Clause 10. The apparatus of claim 9, wherein the at least one processor is configured to indicate at least two of the plurality of SPS correction services based on a request for the mobile wireless device to perform a consistency check between SPS correction services.

Clause 11. The apparatus of claim 9, wherein the position estimate for the mobile wireless device is the future position estimate for the mobile wireless device, and wherein the at least one processor is configured to indicate at least two of the plurality of SPS correction services based on an expected loss of availability, at the future position estimate for the mobile wireless device, of one of the at least two of the plurality of SPS correction services.

Clause 12. The apparatus of claim 8, wherein the apparatus is a server.

Clause 13. The apparatus of claim 8, wherein the apparatus is the mobile wireless device.

Clause 14. The apparatus of claim 8, wherein the at least one processor is configured to determine which of the plurality of SPS correction services for the mobile wireless device to use based on at least one of a positioning accuracy corresponding to at least one of the plurality of SPS correction services, a monetary cost of at least one of the plurality of SPS correction services, a data rate corresponding to at least one of the plurality of SPS correction services, a receiver sensitivity of the mobile wireless device and a receiver sensitivity requirement corresponding to at least one of the plurality of SPS correction services, a power budget of the mobile wireless device and a power requirement corresponding to at least one of the plurality of SPS correction services, a reliability of at least one of the plurality of SPS correction services, at least one quality of the at least one SPS correction, and at least one convergence time corresponding to the at least one SPS correction.

Clause 15. An apparatus comprising:
means for receiving crowdsourced SPS correction information indicating: (1) a location corresponding to the crowdsourced SPS correction information; (2) a plurality of SPS correction services; (3) at least one SPS correction for each of the plurality of SPS correction services; and (4) at least one respective correction service characteristic for each of at least one of the plurality of SPS correction services;
means for obtaining a position estimate for a mobile wireless device, the position estimate for the mobile wireless device comprising one of a present position estimate for the mobile wireless device or a future position estimate for the mobile wireless device; and
means for indicating, based on the position estimate, which of the plurality of SPS correction services are available for the mobile wireless device to use to correct at least one SPS signal received by the mobile wireless device to determine an SPS-signal-corrected position estimate for the mobile wireless device.

Clause 16. The apparatus of claim 15, wherein the means for indicating which of the plurality of SPS correction services are available for the mobile wireless device to use comprise means for indicating at least two of the plurality of SPS correction services for the mobile wireless device to use.

Clause 17. The apparatus of claim 16, wherein the means for indicating at least two of the plurality of SPS correction services comprise means for indicating at least two of the plurality of SPS correction services based on a request for the mobile wireless device to perform a consistency check between SPS correction services.

Clause 18. The apparatus of claim 16, wherein the position estimate for the mobile wireless device is the future position estimate for the mobile wireless device, and wherein the means for indicating at least two of the plurality of SPS correction services comprise means for indicating at least two of the plurality of SPS correction services based on an expected loss of availability, at the future position estimate for the mobile wireless device, of one of the at least two of the plurality of SPS correction services.

Clause 19. The apparatus of claim 15, wherein the apparatus is a server.

Clause 20. The apparatus of claim 15, wherein the apparatus is the mobile wireless device.

Clause 21. The apparatus of claim 15, further comprising means for determining which of the plurality of SPS correction services for the mobile wireless device to use based on at least one of a positioning accuracy corresponding to at least one of the plurality of SPS correction services, a monetary cost of at least one of the plurality of SPS correction services, a data rate corresponding to at least one of the plurality of SPS correction services, a receiver sensitivity of the mobile wireless device and a receiver sensitivity requirement corresponding to at least one of the plurality of SPS correction services, a power budget of the mobile wireless device and a power requirement corresponding to at least one of the plurality of SPS correction services, a reliability of at least one of the plurality of SPS correction services, at least one quality of the at least one SPS correction, and at least one convergence time corresponding to the at least one SPS correction.

Clause 22. A non-transitory, processor-readable storage medium comprising processor-readable instructions to cause one or more processors of an apparatus, for selecting a satellite positioning system (SPS) correction service, to:
receive crowdsourced SPS correction information indicating: (1) a location corresponding to the crowdsourced SPS correction information; (2) a plurality of SPS correction services; (3) at least one SPS correction for each of the plurality of SPS correction services; and (4) at least one respective correction service characteristic for each of at least one of the plurality of SPS correction services;
obtain a position estimate for a mobile wireless device, the position estimate for the mobile wireless device comprising one of a present position estimate for the mobile wireless device or a future position estimate for the mobile wireless device; and
indicate, based on the position estimate, which of the plurality of SPS correction services are available for the mobile wireless device to use to correct at least one SPS signal received by the mobile wireless device to determine an SPS-signal-corrected position estimate for the mobile wireless device.

Clause 23. The non-transitory, processor-readable storage medium of claim 22, wherein the processor-readable instructions to cause the one or more processors to indicate which of the plurality of SPS correction services are available for the mobile wireless device to use comprise processor-readable instructions to cause the one or more processors to indicate at least two of the plurality of SPS correction services for the mobile wireless device to use.

Clause 24. The non-transitory, processor-readable storage medium of claim 23, wherein the processor-readable instructions to cause the one or more processors to indicate at least two of the plurality of SPS correction services comprise processor-readable instructions to cause the one or more processors to indicate at least two of the plurality of SPS correction services based on a request for the mobile wireless device to perform a consistency check between SPS correction services.

Clause 25. The non-transitory, processor-readable storage medium of claim 23, wherein the position estimate for the mobile wireless device is the future position estimate for the mobile wireless device, and wherein the processor-readable instructions to cause the one or more processors to indicate at least two of the plurality of SPS correction services comprise processor-readable instructions to cause the one or more processors to indicate at least two of the plurality of SPS correction services based on an expected loss of availability, at the future position estimate for the mobile wireless device, of one of the at least two of the plurality of SPS correction services.

Clause 26. The non-transitory, processor-readable storage medium of claim 22, wherein the apparatus is a server.

Clause 27. The non-transitory, processor-readable storage medium of claim 22, wherein the apparatus is the mobile wireless device.

Clause 28. The non-transitory, processor-readable storage medium of claim 22, further comprising processor-readable instructions to cause the one or more processors to determine which of the plurality of SPS correction services for the mobile wireless device to use based on at least one of a positioning accuracy corresponding to at least one of the plurality of SPS correction services, a monetary cost of at least one of the plurality of SPS correction services, a data rate corresponding to at least one of the plurality of SPS correction services, a receiver sensitivity of the mobile wireless device and a receiver sensitivity requirement corresponding to at least one of the plurality of SPS correction services, a power budget of the mobile wireless device and a power requirement corresponding to at least one of the plurality of SPS correction services, a reliability of at least one of the plurality of SPS correction services, at least one quality of the at least one SPS correction, and at least one convergence time corresponding to the at least one SPS correction.

Clause 29. A method of crowdsourcing satellite positioning system (SPS) correction data, the method comprising:
receiving, at a mobile wireless device, at least one SPS correction provided by an SPS correction service of a plurality of SPS correction services;
determining, at the mobile wireless device, a position estimate for the mobile wireless device based on the at least one SPS correction; and
transmitting, from the mobile wireless device, a correction service message indicating: (1) a location corresponding to the position estimate for the mobile wireless device; (2) the SPS correction service; and (3) at least one correction service characteristic for each of at least one of the plurality of SPS correction services.

Clause 30. The method of claim 29, wherein transmitting the correction service message comprises at least one of:
transmitting the correction service message periodically;
transmitting the correction service message aperiodically in response to accuracy of the position estimate dropping below a threshold positioning accuracy; and
transmitting the correction service message semi-persistently in response to accuracy of the position estimate dropping below the threshold positioning accuracy.

Clause 31. The method of claim 29, wherein the at least one correction service characteristic corresponds to the SPS correction service and is at least one of:
whether the SPS correction service is available;
cost of the SPS correction service;
reliability of the SPS correction service;
data rate of the SPS correction service;
geographic coverage of the SPS correction service;
satellite identifier; and
minimum receiver sensitivity.

Clause 32. The method of claim 29, wherein the at least one correction service characteristic corresponds to the at least one SPS correction and is at least one of:
correction quality;
signal type for the at least one SPS correction;
correction type including at least one of clock error, orbit error, satellite bias, atmospheric error, and multipath; and
a power consumption estimate for decoding the at least one SPS correction.

Clause 33. The method of claim 29, wherein the at least one correction service characteristic corresponds to the position estimate for the mobile wireless device and is at least one of:
a positioning method;
a position estimate accuracy; and
a positioning method convergence time.

Clause 34. The method of claim 29, wherein the correction service message further indicates an environment corresponding to the position estimate for the mobile wireless device.

Clause 35. A mobile wireless device comprising:
at least one memory;
at least one transceiver; and
at least one processor communicatively coupled to the at least one memory and the at least one transceiver and configured to:
   receive, via the at least one transceiver, at least one SPS correction provided by an SPS correction service of a plurality of SPS correction services;
   determine a position estimate for the mobile wireless device based on the at least one SPS correction; and
   transmit, via the at least one transceiver, a correction service message indicating: (1) a location corresponding to the position estimate for the mobile wireless device; (2) the SPS correction service; and (3) at least one correction service characteristic for each of at least one of the plurality of SPS correction services.

Clause 36. The mobile wireless device of claim 35, wherein to transmit the correction service message the at least one processor is at least one of:
configured to transmit the correction service message periodically;
configured to transmit the correction service message aperiodically in response to accuracy of the position estimate dropping below a threshold positioning accuracy; and
configured to transmit the correction service message semi-persistently in response to accuracy of the position estimate dropping below the threshold positioning accuracy.

Clause 37. The mobile wireless device of claim 35, wherein the at least one correction service characteristic corresponds to the SPS correction service and is at least one of:
whether the SPS correction service is available;
cost of the SPS correction service;
reliability of the SPS correction service;
data rate of the SPS correction service;
geographic coverage of the SPS correction service;
satellite identifier; and
minimum receiver sensitivity.

Clause 38. The mobile wireless device of claim 35, wherein the at least one correction service characteristic corresponds to the at least one SPS correction and is at least one of:
correction quality;
signal type for the at least one SPS correction;
correction type including at least one of clock error, orbit error, satellite bias, atmospheric error, and multipath; and
a power consumption estimate for decoding the at least one SPS correction.

Clause 39. The mobile wireless device of claim 35, wherein the at least one correction service characteristic corresponds to the position estimate for the mobile wireless device and is at least one of:
a positioning method;
a position estimate accuracy; and
a positioning method convergence time.

Clause 40. The mobile wireless device of claim 35, wherein the correction service message further indicates an environment corresponding to the position estimate for the mobile wireless device.

Clause 41. A mobile wireless device comprising:
means for receiving at least one SPS correction provided by an SPS correction service;
means for determining a position estimate for the mobile wireless device based on the at least one SPS correction of a plurality of SPS correction services; and
means for transmitting a correction service message indicating: (1) a location corresponding to the position estimate for the mobile wireless device; (2) the SPS correction service; and (3) at least one correction service characteristic for each of at least one of the plurality of SPS correction services.

Clause 42. The mobile wireless device of claim 41, wherein the means for transmitting the correction service message comprise at least one of:
means for transmitting the correction service message periodically; means for transmitting the correction service message aperiodically in response to accuracy of the position estimate dropping below a threshold positioning accuracy; and
means for transmitting the correction service message semi-persistently in response to accuracy of the position estimate dropping below the threshold positioning accuracy.

Clause 43. The mobile wireless device of claim 41, wherein the at least one correction service characteristic corresponds to the SPS correction service and is at least one of:
whether the SPS correction service is available;
cost of the SPS correction service;
reliability of the SPS correction service;
data rate of the SPS correction service;
geographic coverage of the SPS correction service;
satellite identifier; and
minimum receiver sensitivity.

Clause 44. The mobile wireless device of claim 41, wherein the at least one correction service characteristic corresponds to the at least one SPS correction and is at least one of:
correction quality;
signal type for the at least one SPS correction;
correction type including at least one of clock error, orbit error, satellite bias, atmospheric error, and multipath; and
a power consumption estimate for decoding the at least one SPS correction.

Clause 45. The mobile wireless device of claim 41, wherein the at least one correction service characteristic corresponds to the position estimate for the mobile wireless device and is at least one of:
a positioning method;
a position estimate accuracy; and
a positioning method convergence time.

Clause 46. The mobile wireless device of claim 41, wherein the correction service message further indicates an environment corresponding to the position estimate for the mobile wireless device.

Clause 47. A non-transitory, processor-readable storage medium comprising processor-readable instructions to cause one or more processors of a mobile wireless device, for crowdsourcing satellite positioning system (SPS) correction data, to:
receive at least one SPS correction provided by an SPS correction service of a plurality of SPS correction services;
determine a position estimate for the mobile wireless device based on the at least one SPS correction; and
transmit a correction service message indicating: (1) a location corresponding to the position estimate for the mobile wireless device; (2) the SPS correction service; and (3) at least one correction service characteristic for each of at least one of the plurality of SPS correction services.

Clause 48. The non-transitory, processor-readable storage medium of claim 47, wherein the processor-readable instructions to cause the one or more processors to transmit the correction service message comprise at least one of:
processor-readable instructions to cause the one or more processors to transmit the correction service message periodically;
processor-readable instructions to cause the one or more processors to transmit the correction service message aperiodically in response to accuracy of the position estimate dropping below a threshold positioning accuracy; and
processor-readable instructions to cause the one or more processors to transmit the correction service message semi-persistently in response to accuracy of the position estimate dropping below the threshold positioning accuracy.

Clause 49. The non-transitory, processor-readable storage medium of claim 47, wherein the at least one correction service characteristic corresponds to the SPS correction service and is at least one of:
whether the SPS correction service is available;
cost of the SPS correction service;
reliability of the SPS correction service;
data rate of the SPS correction service;
geographic coverage of the SPS correction service;
satellite identifier; and
minimum receiver sensitivity.

Clause 50. The non-transitory, processor-readable storage medium of claim 47, wherein the at least one correction service characteristic corresponds to the at least one SPS correction and is at least one of:
correction quality;
signal type for the at least one SPS correction;
correction type including at least one of clock error, orbit error, satellite bias, atmospheric error, and multipath; and
a power consumption estimate for decoding the at least one SPS correction.

Clause 51. The non-transitory, processor-readable storage medium of claim 47, wherein the at least one correction service characteristic corresponds to the position estimate for the mobile wireless device and is at least one of:
a positioning method;
a position estimate accuracy; and
a positioning method convergence time.

Clause 52. The non-transitory, processor-readable storage medium of claim 47, wherein the correction service message further indicates an environment corresponding to the position estimate for the mobile wireless device.

### Other considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method of selecting a satellite positioning system (SPS) correction service, the method comprising:
receiving, at an apparatus, crowdsourced SPS correction information indicating: (1) a location corresponding to the crowdsourced SPS correction information; (2) a plurality of SPS correction services; (3) at least one SPS correction for each of the plurality of SPS correction services; and (4) at least one respective correction service characteristic for each of at least one of the plurality of SPS correction services;
obtaining, at the apparatus, a position estimate for a mobile wireless device, the position estimate for the mobile wireless device comprising one of a present position estimate for the mobile wireless device or a future position estimate for the mobile wireless device; and
indicating, by the apparatus and based on the position estimate, which of the plurality of SPS correction services are available for the mobile wireless device to use to correct at least one SPS signal received by the mobile wireless device to determine an SPS-signal-corrected position estimate for the mobile wireless device.

2. The method of claim 1, wherein indicating which of the plurality of SPS correction services are available for the mobile wireless device to use comprises indicating at least two of the plurality of SPS correction services for the mobile wireless device to use.

3. The method of claim 2, wherein indicating at least two of the plurality of SPS correction services is based on a request for the mobile wireless device to perform a consistency check between SPS correction services.

4. The method of claim 2, wherein the position estimate for the mobile wireless device is the future position estimate for the mobile wireless device, and wherein indicating at least two of the plurality of SPS correction services is based on an expected loss of availability, at the future position estimate for the mobile wireless device, of one of the at least two of the plurality of SPS correction services.

5. The method of claim 1, wherein the apparatus is a server.

6. The method of claim 1, wherein the apparatus is the mobile wireless device.

7. The method of claim 1, further comprising determining which of the plurality of SPS correction services for the mobile wireless device to use based on at least one of a positioning accuracy corresponding to at least one of the plurality of SPS correction services, a monetary cost of at least one of the plurality of SPS correction services, a data rate corresponding to at least one of the plurality of SPS correction services, a receiver sensitivity of the mobile wireless device and a receiver sensitivity requirement corresponding to at least one of the plurality of SPS correction services, a power budget of the mobile wireless device and a power requirement corresponding to at least one of the plurality of SPS correction services, a reliability of at least one of the plurality of SPS correction services, at least one quality of the at least one SPS correction, and at least one convergence time corresponding to the at least one SPS correction.

8. An apparatus comprising:
at least one memory;
at least one transceiver; and
at least one processor communicatively coupled to the at least one memory and the at least one transceiver and configured to:
receive, via the at least one transceiver, crowdsourced SPS correction information indicating: (1) a location corresponding to the crowdsourced SPS correction information; (2) a plurality of SPS correction services; (3) at least one SPS correction for each of the plurality of SPS correction services; and (4) at least one respective correction service characteristic for each of at least one of the plurality of SPS correction services;
obtain a position estimate for a mobile wireless device, the position estimate for the mobile wireless device comprising one of a present position estimate for the mobile wireless device or a future position estimate for the mobile wireless device; and
indicate, based on the position estimate, which of the plurality of SPS correction services are available for the mobile wireless device to use to correct at least one SPS signal received by the mobile wireless device to determine an SPS-signal-corrected position estimate for the mobile wireless device.

9. The apparatus of claim 8, wherein to indicate which of the plurality of SPS correction services are available for the mobile wireless device to use the at least one processor is configured to indicate at least two of the plurality of SPS correction services for the mobile wireless device to use.

10. The apparatus of claim 9, wherein the at least one processor is configured to indicate at least two of the plurality of SPS correction services based on a request for the mobile wireless device to perform a consistency check between SPS correction services.

11. The apparatus of claim 9, wherein the position estimate for the mobile wireless device is the future position estimate for the mobile wireless device, and wherein the at least one processor is configured to indicate at least two of the plurality of SPS correction services based on an expected loss of availability, at the future position estimate for the mobile wireless device, of one of the at least two of the plurality of SPS correction services.

12. The apparatus of claim 8, wherein the apparatus is a server.

13. The apparatus of claim 8, wherein the apparatus is the mobile wireless device.

14. The apparatus of claim 8, wherein the at least one processor is configured to determine which of the plurality of SPS correction services for the mobile wireless device to use based on at least one of a positioning accuracy corresponding to at least one of the plurality of SPS correction services, a monetary cost of at least one of the plurality of SPS correction services, a data rate corresponding to at least one of the plurality of SPS correction services, a receiver sensitivity of the mobile wireless device and a receiver sensitivity requirement corresponding to at least one of the plurality of SPS correction services, a power budget of the mobile wireless device and a power requirement corresponding to at least one of the plurality of SPS correction services, a reliability of at least one of the plurality of SPS correction services, at least one quality of the at least one SPS correction, and at least one convergence time corresponding to the at least one SPS correction.

15. A method of crowdsourcing satellite positioning system (SPS) correction data, the method comprising:
receiving, at a mobile wireless device, at least one SPS correction provided by an SPS correction service of a plurality of SPS correction services;
determining, at the mobile wireless device, a position estimate for the mobile wireless device based on the at least one SPS correction; and
transmitting, from the mobile wireless device, a correction service message indicating: (1) a location corresponding to the position estimate for the mobile wireless device; (2) the SPS correction service; and (3) at least one correction service characteristic for each of at least one of the plurality of SPS correction services.

16. The method of claim 15, wherein transmitting the correction service message comprises at least one of:
transmitting the correction service message periodically;
transmitting the correction service message aperiodically in response to accuracy of the position estimate dropping below a threshold positioning accuracy; and
transmitting the correction service message semi-persistently in response to accuracy of the position estimate dropping below the threshold positioning accuracy.

17. The method of claim 15, wherein the at least one correction service characteristic corresponds to the SPS correction service and is at least one of:
whether the SPS correction service is available;
cost of the SPS correction service;
reliability of the SPS correction service;
data rate of the SPS correction service;
geographic coverage of the SPS correction service;
satellite identifier; and
minimum receiver sensitivity.

18. The method of claim 15, wherein the at least one correction service characteristic corresponds to the at least one SPS correction and is at least one of:
correction quality;
signal type for the at least one SPS correction;
correction type including at least one of clock error, orbit error, satellite bias, atmospheric error, and multipath; and
a power consumption estimate for decoding the at least one SPS correction.

19. The method of claim 15, wherein the at least one correction service characteristic corresponds to the position estimate for the mobile wireless device and is at least one of:
a positioning method;
a position estimate accuracy; and
a positioning method convergence time.

20. The method of claim 15, wherein the correction service message further indicates an environment corresponding to the position estimate for the mobile wireless device.

21. A mobile wireless device comprising:
at least one memory;
at least one transceiver; and
at least one processor communicatively coupled to the at least one memory and the at least one transceiver and configured to:
receive, via the at least one transceiver, at least one SPS correction provided by an SPS correction service of a plurality of SPS correction services;
determine a position estimate for the mobile wireless device based on the at least one SPS correction; and
transmit, via the at least one transceiver, a correction service message indicating: (1) a location corresponding to the position estimate for the mobile wireless device; (2) the SPS correction service; and (3) at least one correction service characteristic for each of at least one of the plurality of SPS correction services.

22. The mobile wireless device of claim 21, wherein to transmit the correction service message the at least one processor is at least one of:
configured to transmit the correction service message periodically;
configured to transmit the correction service message aperiodically in response to accuracy of the position estimate dropping below a threshold positioning accuracy; and
configured to transmit the correction service message semi-persistently in response to accuracy of the position estimate dropping below the threshold positioning accuracy.

23. The mobile wireless device of claim 21, wherein the at least one correction service characteristic corresponds to the SPS correction service and is at least one of:
whether the SPS correction service is available;
cost of the SPS correction service;
reliability of the SPS correction service;
data rate of the SPS correction service;
geographic coverage of the SPS correction service;
satellite identifier; and
minimum receiver sensitivity.

24. The mobile wireless device of claim 21, wherein the at least one correction service characteristic corresponds to the at least one SPS correction and is at least one of:
correction quality;
signal type for the at least one SPS correction;
correction type including at least one of clock error, orbit error, satellite bias, atmospheric error, and multipath; and
a power consumption estimate for decoding the at least one SPS correction.

25. The mobile wireless device of claim 21, wherein the at least one correction service characteristic corresponds to the position estimate for the mobile wireless device and is at least one of:
a positioning method;
a position estimate accuracy; and
a positioning method convergence time.

26. The mobile wireless device of claim 21, wherein the correction service message further indicates an environment corresponding to the position estimate for the mobile wireless device.
